(19) United States
(12) Patent Application Publication
(10) Pub. No.: US 2004/0163679 A1
(43) Pub. Date: Aug. 26, 2004

(54) Device for measuring the turbidity of the rinsing liquid in a dishwasher

(76) Inventors: Clemens Jung, Bruecken (DE); Peter Schwarzweller, St. Wendel (DE); Konrad Petry, Mandelbachteil 3 (DE); Reinhold Baltes, Roschberg (DE)

Correspondence Address: WHIRLPOOL PATENTS COMPANY - MD 0750, 500 RENAISSANCE DRIVE - SUITE 102, ST. JOSEPH, MI, 49085, US

(21) Appl. No.: 10/713,304

(22) Filed: Nov. 14, 2003

(30) Foreign Application Priority Data
Nov. 14, 2002 (DE) 10253009.2

(51) Int. Cl. B08B 7/04

(52) U.S. Cl. 134/25.2; 134/18; 134/57 D; 134/113

(57) ABSTRACT

The invention relates to a device for measuring the turbidity of the rinsing liquid in a dishwasher by means of a turbidity sensor. If it is provided according to the invention that the turbidity sensor is incorporated into the inlet flow of the circulation pump into the water drain shaft of the dishwasher and continuously measures the turbidity of the rinsing liquid, that the upper and lower spraying plane can be operated alternately, that a difference value can be derived from the turbidity values associated with upper and lower spray plane, that parameters for the quantity and the type of soiling can be derived from the turbidity values and the difference value and that the further rinse program can be established and controlled with these parameters, then, with low complexity, measurement values for the degree of soiling can be obtained, from which value parameters for the further course of the program can be delivered.

### BACKGROUND OF THE INVENTION

1. Field of the Invention

The invention relates to a device for measuring the turbidity of the rinsing liquid in a dishwasher by means of a turbidity sensor.

2. Description of the Related Art

Dishwashers available on the market up to now increasingly include turbidity sensors for measuring the turbidity of the rinsing liquid and for influencing the course of a rinse program as a function of the turbidity value of the rinsing liquid. Many dishwashers of today include an upper and a lower spray plane with associated spray arms, which can be operated simultaneously or separately from one another in an alternating manner. At the same time, the rinsing liquid is circulated by a circulation pump where the rinsing liquid is supplied to the circulation pump via the water drain shaft. The output of the circulation pump is then connected alternately to the upper and lower spray arm.

### SUMMARY OF THE INVENTION

It is an object of the present invention to specify, for a dishwasher of this type, a device for measuring the turbidity of the rinsing liquid. The device supplies measured values, which provides information on the quantity and type of the soiling of the rinsing liquid. The measured values can represent parameters which are used for influencing the rinsing program.

In an exemplary embodiment of the invention, this object may be achieved by incorporating a turbidity sensor into the inlet flow of the circulation pump in the water drain shaft of the dishwasher and continuously measuring the turbidity of the rinsing liquid. The upper and lower spray plane can be operated alternately and a difference value can be derived from the turbidity values associated with the upper and lower spray plane. The parameters for the quantity and the type of soiling can then be derived from the turbidity values and the difference value, and the rinse program can be established or modified based on these parameters.

By disposing the turbidity sensor in the inlet flow of the circulation pump in the water drain shaft of the dishwasher, there is no special measuring chamber for measuring the turbidity. The measuring is effected with the rinsing liquid circulating, without shutting-down the circulation pump, which means that the rinsing process is not disturbed. Over and above this, a clear determining of the turbidity can be derived from the two turbidity values of the upper and the lower spray plane. At the same time it can be considered that, with identical soiling of the rinsing liquid, the turbidity value when the upper spray plane is operated is smaller than the turbidity value when the lower spray plane is operated, as well as that the velocity of flow of the rinsing liquid when the upper spray plane is operated is less than the velocity of flow when the lower spray plane is operated.

If it is also provided that, the increase in the turbidity values is derivable, and in that the length of time until the increase in the turbidity values has achieved the value zero is determinable, then it is possible to make a statement on the solubility of the soiling of the dishes, which statement can be used as a parameter for the solubility of the soiling of the dishes in the rinsing program.

### BRIEF DESCRIPTION OF THE DRAWINGS

The invention is described in more detail by way of diagrams. In which:

FIG. 1 is a schematic illustration of the dishwasher in accordance with the exemplary embodiment of the present invention;

FIG. 2 is the turbidity as a function of the quantity of soiling;

FIG. 3 is the quantity of soiling as a function of the length of time of the rinsing operation for various types of soiling and rinsing with hot water; and

FIG. 4 is the quantity of soiling as a function of the length of time of the rinsing operation for various types of soiling and rinsing with cold water.

### DETAILED DESCRIPTION

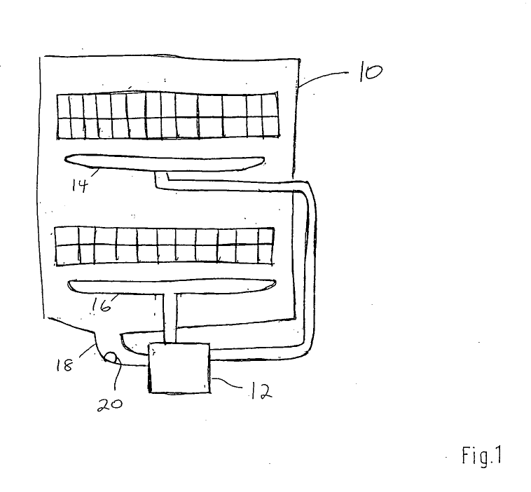

In FIG. 1 there is shown a dishwasher having a tub 10. A circulation pump 12 is provided for supplying liquid to a first spray arm 14 operating in an upper spray plane and a second spray arm 16 operating in a lower spray plane. The pump may supply liquid either simultaneously or separately to each spray arm in an alternating manner. A water drain shaft or inlet shaft 18 supplies liquid to the circulation pump 12 which has outputs connected to the upper and lower spray arms 14 and 16, respectively. A turbidity sensor 20 is incorporated into the inlet shaft 18 such that the turbidity of the inlet flow into the pump is measured.

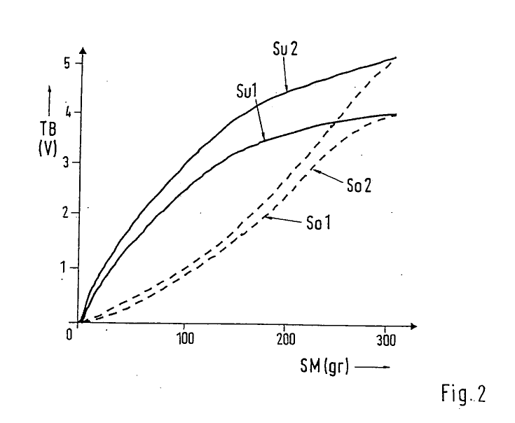

In the diagram in FIG. 2, the turbidity TB is specified in volts of the electronic turbidity sensor as a function of the quantity SM of the soiling in grams. At the same time, the measured value for the turbidity TB, with the operation of the upper spray plane, is specified for two different types of soiling So1 and So2. The curves, identified as Su1 and Su2, specify the turbidity TB for two different types of soiling Su1 and Su2 with the operation of the lower spray plane. It can be deduced from the curves that between both turbidity values of the curves Su1 and So1, or respectively Su2 and So2, for each type of soiling a difference value can be derived which is a function of the type of soiling and the quantity SM of the soiling. The measuring of the turbidity according to the invention with the subsequent influencing of the rinsing program is based on this knowledge. It can also be derived from the curves Su1 and So1, or respectively Su2 and So2, that the turbidity sensor, with identical soiling, always emits a higher turbidity value TM when the lower spray plane is operated than when the upper spray plane is operated, i.e. Su1>So1 or respectively Su2>So2 and between both values there is a respective difference in the turbidity values, which increases with the quantity SM and then reduces again by the same quantity. Another parameter for influencing the rinsing program can be derived from the two curves Su1 and So1, or respectively Su2 and So2, which approximate at a maximum degree of soiling and do not increase any more.

The length of time elapsing from the beginning of the pre-rinse operation up to this moment is a measurement for the solubility of the soiling of the dishes, i.e. up to the moment when, without changing the operating conditions, no more soiling is dissolved from the dishes. Using an evaluation software, the values of the turbidity and their difference as well as the determined length of time, the quantity and the type of soiling on the dishes can be analyzed and established and can be used for adjusting and modifying the further course of the rinsing program.

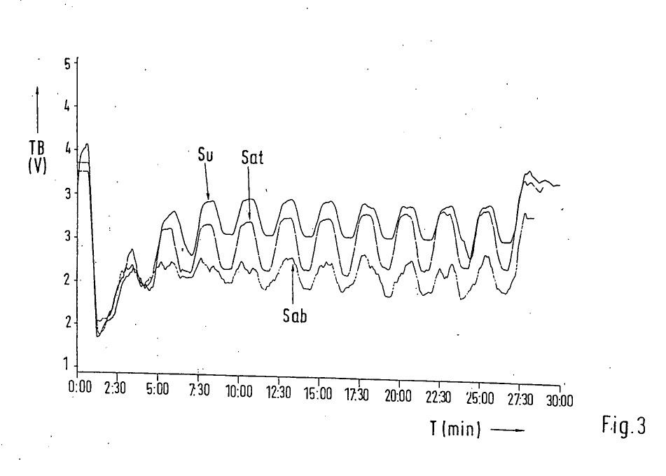

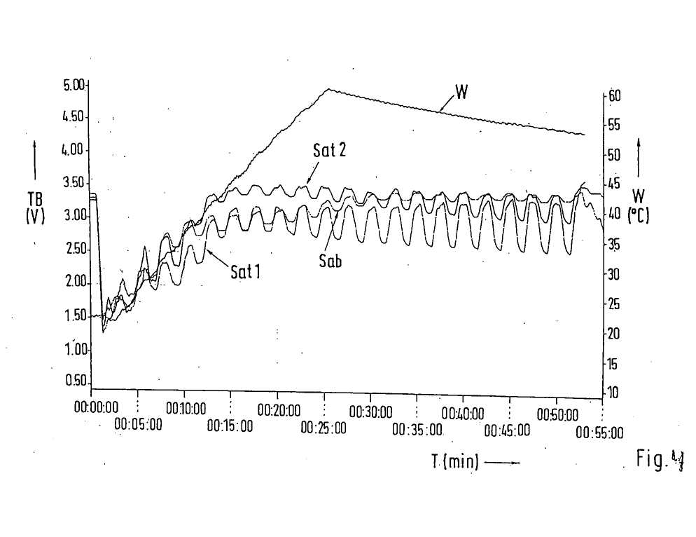

In FIGS. 3 and 4, each with three different types of soiling on the dishes, the turbidity values TB are shown as a function of the length of time T of the pre-rinse operation. The curves show a rhythmic up and down of the turbidity value TB, which is conditioned by the alternating starting-up of the lower and upper spray plane. At the same time, the higher turbidity value is associated with the respective lower spray plane and the lower turbidity value is associated with the respective upper spray plane. This is applicable to all curves Sab, Sat and Sll. Where the soiling is burnt-on, little soiling is dissolved in the period T of the pre-rinse operation, as is shown in the curve Sab. Where the soiling is dried-on, more soiling is dissolved in the same period T under the same conditions, as is shown in the curve Sat with higher turbidity values TB. Finally, where the soiling is easily dissolvable, even more soiling is dissolved, which results in an even higher turbidity level TB, as can be seen in the curve Sll. At the same time the maxima and minima of the curves are retained. Only the difference in the turbidity values TB of the various curves can change and can also be used to influence the further course of the rinsing program. It can also be deduced from the curves Sab, Sat and Sll that after a certain length of time, for example 10 to 15 minutes or respectively 20 minutes after the beginning of the pre-rinse operation, the turbidity values TB do not change any more. This can be evaluated as a sign that, without any change in the operating conditions and consequently the rinsing program, the cleaning of the dishes cannot be improved any more and therefore the rinsing program must be continued with consideration given to the determined turbidity values, the difference value of the turbidity values and the determined length of time.

The influence of the temperature of the rinsing liquid can also be seen in the curves in FIGS. 3 and 4. A rinsing liquid at a temperature of 15° C. is used in the tests with the three different types of soiling Sab, Sat and Sll in FIG. 3. In this case, less soiling is dissolved from the dishes than in the tests in FIG. 4 where hot water is used and this is reflected in the different turbidity values TB and various difference values in FIGS. 3 and 4.

Where hot water is used as the rinsing liquid, the turbidity factor TB does not oscillate very strongly with different types of soiling, even when the quantity of soiling is doubled, as is shown in the curve Sat2 compared to the curve Sat1 in FIG. 4. The course of the water temperature W is specified in ° C. for the pre-rinse operation by the curve, identified as such, and the associated right-hand abscissa W.

It can also be seen from the curves in FIGS. 3 and 4 that the turbidity values TB increase in a different manner at the beginning of the pre-rinse operation. An increase can be seen here for both the maxima (lower spray plane) and minima (upper spray plane). In the different curves the maxima and minima pass over into approximately constant values after variable times such that, depending on the soiling, the length of time taken until the increase in the turbidity values TB assume the value zero also changes. A statement on the type of soiling can be derived from this, both with cold rinsing liquid (15° C. bi FIG. 3) and with heated-up rinsing liquid (W in FIG. 4).

As is shown in FIGS. 3 and 4, with known types of soiling, tests can produce the parameters which are to be used for the continued course of the program in order to optimize a cleaning and drying operation for the dishes and to achieve this with the smallest power and water consumption. The values obtained in tests are deposited in the control unit and are called-up each time the dishwasher is operated as a function of the turbidity values, difference values and lengths of time, determined in the current pre-rinse operation, in order to establish the further course of the program.

We claim:

1. A device for measuring the turbidity of the rinsing liquid in a dishwasher by means of a turbidity sensor, wherein that the turbidity sensor is incorporated into the inlet flow of the circulation pump into the water drain shaft of the dishwasher and continuously measures the turbidity of the rinsing liquid, and in that the upper and lower spray plane can be operated alternately, and in that a difference value is derivable from the turbidity values associated with the upper and lower spray plane, and in that parameters for the quantity and the type of soiling can be derived from the turbidity values and the difference value, and in that the continued course of the rinse program can be established and controlled with these parameters.

2. The device according to claim 1, wherein the turbidity value associated with upper spray plane is smaller than the turbidity value associated with the lower spray plane when the soiling of the rinsing liquid is identical.

3. The device according to claim 2, wherein the velocity of the flow of the rinsing liquid when the upper spray plane is operated is less than the velocity of the flow when the lower spray plane is operated.

4. The device according to claim 1, wherein an increase in the turbidity values is derivable from the length of time it takes until the turbidity values have achieved a zero value.

5. The device according to claim 4, wherein a parameter for the solubility of the soiling of the dishes is derivable from the length of time.

6. The device according to claim 5, wherein the continued course of the rinsing program can be established and controlled with the parameter for the solubility of the soiling of the dishes.

7. A method establishing a rinse program in a dishwasher having upper and lower spray planes and a turbidity sensor incorporated into the inlet flow of the circulation pump and in communication with the spray planes, the method comprising the steps of:;
alternately operating the upper and lower spray planes;
measuring turbidity values associated with the upper and lower spray planes;
deriving a difference value between the turbidity values;
deriving parameters for the type and quantity of soil based on the turbidity and difference values;
establishing a rinse program based on the derived parameters.

8. The method according to claim 7, further comprising the step of deriving a parameter for the solubility of the soiling of the dishes from the length of time it takes until the turbidity values have achieved a zero value.
